(19) United States
(12) Patent Application Publication
(10) Pub. No.: US 2017/0374361 A1
(43) Pub. Date: Dec. 28, 2017

(54) Method and System Of Controlling A Video Content System

(71) Applicant: BEAMR IMAGING LTD., Tel-Aviv (IL)

(72) Inventors: Sharon CARMEL, Ramat Hasharon (IL); Dror GILL, Haifa (IL); Tamar SHOHAM, Netanya (IL); Shevach RIABTSEV, Haifa (IL)

(21) Appl. No.: 15/528,468

(22) PCT Filed: Jan. 27, 2016
(86) PCT No.: PCT/IL2016/050086

§ 371 Date: May 19, 2017

Related U.S. Application Data
(60) Provisional application No. 62/108,577, filed on Jan. 28, 2015.

(51) Int. Cl. H04N 19/103; H04N 19/15; H04N 19/124

(52) U.S. Cl. CPC H04N 19/103; H04N 19/124; H04N 19/15

(57) ABSTRACT

There is provided a computerized method and system of controlling a video content system based on an input video bitstream, the input video bitstream including encoded data encoded from one or more input frames of a video sequence, the method comprising: extracting, from the input video bitstream, encoding information associated with each input frame of said one or more input frames, the encoding information being used in an encoding process of the input frame to encode pixels included in the input frame into corresponding section of the input video bitstream; calculating one or more intricateness values each for a respective input frame based on the encoding information associated therewith, each intricateness value being indicative of encoding difficulty of the respective input frame in the encoding process; and providing a configuration instruction for controlling a video content system by using the one or more intricateness values.

### TECHNICAL FIELD

The presently disclosed subject matter relates, in general, to the field of video content system control and configuration.

### BACKGROUND

With the fast development of imaging and video technologies, video plays a key role as a mechanism of information exchange, transmission or storage nowadays. Video content system, such as, by way of non-limiting example, video encoding system, video quality evaluation system, video content management system, video compression and/or recompression system, has been widely deployed in many aspects. In such a video content system, sometimes it can be beneficial to use certain features of a video input to configure or control the system. For example, some video encoders, or modules thereof may use characteristics or features of input video frames to control encoder decisions.

Various techniques have been developed in this aspect and references considered to be relevant as background to the presently disclosed subject matter are listed below. Acknowledgement of the references herein is not to be inferred as meaning that these are in any way relevant to the patentability of the presently disclosed subject matter.

U.S. Pat. No. 6,937,773 (Nozawa et al.) issued on Aug. 30, 2005 discloses a method and apparatus of image encoding. An image signal is input from an image input unit and is divided into different spatial frequency bands by applying a discrete wavelet transform thereto using a discrete wavelet transformation unit. On the basis of values of spatial frequency components, a region-of-interest processor extracts a region of interest by obtaining a distribution of motion vectors in the input image. A quantization unit applies quantization processing to the extracted region of interest and different quantization processing to other regions, and an encoder encodes the quantized image signal. Alternatively, motion of an image contained in the input image may be detected and the region of interest may be obtained based upon motion of this image.

“A ROI quality adjustable rate control scheme for low bitrate video coding” (L. Yang, L. Zhang, S. Ma, and D. Zhao)” in Proceedings of the 27th conference on Picture Coding Symposium, IEEE, May 2009, pp. 1-4 proposes a Region of Interest (ROI) based rate control algorithm for video communication systems, in which the subjective quality of ROI can be adjusted according to users' requirements. In the proposed scheme, in order to analyze the relationship between subjective quality and encoding parameters, a structural similarity index map-quantization parameter (SSIM-QP) model is established. Through this relation, the possible visual quality range of ROI is defined according to the range of ROI QP, which is predicted by rate control algorithm. Then, with interest levels being identified within the visual quality range, resource allocation to ROI is determined. Finally, considering both the quality of ROI and the entire frame, resource allocation is slightly adjusted.

### GENERAL DESCRIPTION

In accordance with certain aspects of the presently disclosed subject matter, there is provided a computerized method of controlling a video content system based on an input video bitstream, the input video bitstream including encoded data encoded from one or more input frames of a video sequence, the method comprising: extracting, from the input video bitstream, encoding information associated with each input frame of the one or more input frames, the encoding information being used in an encoding process of the input frame to encode pixels included in the input frame into corresponding section of the input video bitstream; calculating one or more intricateness values each for a respective input frame based on the encoding information associated therewith, each intricateness value being indicative of encoding difficulty of the respective input frame in the encoding process; and providing a configuration instruction for controlling a video content system by using the one or more intricateness values.

In accordance with other aspects of the presently disclosed subject matter, there is provided a computerized system of controlling a video content system based on an input video bitstream, the input video bitstream including encoded data encoded from one or more input frames of a video sequence, the system comprising a processor operatively coupled with a memory and configured to: extract, from the input video bitstream, encoding information associated with each input frame of the one or more input frames, the encoding information being used in an encoding process of the input frame to encode pixels included in the input frame into corresponding section of the input video bitstream; calculate one or more intricateness values each for a respective input frame based on the encoding information associated therewith, each intricateness value being indicative of encoding difficulty of the respective input frame in the encoding process; and provide a configuration instruction for controlling a video content system by using the one or more intricateness values.

In accordance with further aspects of the presently disclosed subject matter, and optionally, in combination with any of the above aspects, the encoding information can include bit consumption and encoding parameters used to encode each input frame. The encoding parameters can include one or more of the following: encoding mode, quantization parameter, and motion vectors used to encode each input frame. The intricateness value can be calculated based on the bit consumption and the quantization parameter used to encode the input frame. The input video bitstream can be decoded to the one or more input frames by the video content system, and wherein the controlling comprises instructing the video content system to recompress the input frames to respective candidate recompressed frames using the intricateness values. The instructing can comprise instructing the video content system to adjust one or more quantization parameters using the one or more intricateness values and recompress the input frames to respective candidate recompressed frames based on the adjusted quantization parameters. The one or more input frames decoded from the input video bitstream and corresponding candidate recompressed frames recompressed from the one or more input frames can be obtained, wherein the controlling comprises instructing the video content system to evaluate compression quality of the candidate recompressed frames using the intricateness values. The corresponding candidate recompressed frames can be decoded from an input recompressed video bitstream corresponding to the input video bitstream. The controlling can further comprise: instructing the video content system to calculate a quality score for each of the candidate recompressed frames based on the intricateness value, the quality score being calculated using a quality measure indicative of perceptual quality of a respective candidate recompressed frame. The controlling can further comprise: instructing the video content system to adjust a quality criterion for selected input frames, the adjusted quality criterion being used by the video content system to determine whether perceptual quality of the candidate recompressed frames of the selected input frames meets the adjusted quality criterion. The providing a configuration instruction can comprise instructing a video encoder to recompress an input frame having an intricateness value lower than a previous input frame by using the same encoding instruction as the previous input frame. The intricateness value can be an estimation of amount of information contained in the respective input frame to be encoded.

In accordance with other aspects of the presently disclosed subject matter, there is provided a computerized method of controlling a video content system based on input video bitstream, the input video bitstream including encoded data encoded from one or more input frames of a video sequence, each input frame comprising a plurality of tiles, each tile including one or more blocks, the method comprising: i) extracting, from the input video bitstream, encoding information associated with each block included in a tile of an input frame, the encoding information being used in an encoding process of the block to encode pixels included in the block into corresponding section of the input video bitstream; ii) calculating a plurality of intricateness values each for a block in the tile based on the encoding information associated therewith, each intricateness value being indicative of encoding difficulty of the block in the encoding process; iii) repeating i) and ii) for each tile included in each input frame, giving rise to a plurality of intricateness values for each input frame; iv) providing a configuration instruction for controlling a video content system by using the plurality of intricateness values for each input frame.

In accordance with other aspects of the presently disclosed subject matter, there is provided a computerized system of controlling a video content system based on input video bitstream, the input video bitstream including encoded data encoded from one or more input frames of a video sequence, each input frame comprising a plurality of tiles, each tile including one or more blocks, the system comprising a processor operatively coupled with a memory and configured to: i) extract, from the input video bitstream, encoding information associated with each block included in a tile of an input frame, the encoding information being used in an encoding process of the block to encode pixels included in the block into corresponding section of the input video bitstream; ii) calculate a plurality of intricateness values each for a block in the tile based on the encoding information associated therewith, each intricateness value being indicative of encoding difficulty of the block in the encoding process; iii) repeat said i) and ii) for each tile included in each input frame, giving rise to a plurality of intricateness values for each input frame; iv) provide a configuration instruction for controlling a video content system by using the plurality of intricateness values for each input frame.

In accordance with further aspects of the presently disclosed subject matter, and optionally, in combination with any of the appropriate above aspects, the encoding information can include bit consumption and encoding parameters used to encode the block. The encoding parameters can include one or more of the following: encoding mode, quantization parameter, and motion vectors used to encode the block. The intricateness value can be calculated based on the bit consumption and the quantization parameter used to encode the block. The input video bitstream can be decoded to the one or more input frames by the video content system, and the controlling comprises instructing the video content system to recompress the input frames to respective candidate recompressed frames using the intricateness values, each candidate recompressed frame comprising a plurality of candidate recompressed tiles corresponding to the plurality of tiles, each candidate recompressed tile including one or more candidate recompressed blocks corresponding to the one or more blocks. The instructing can comprise instructing the video content system to adjust one or more quantization parameters using the one or more intricateness values and recompress the input frames to respective candidate recompressed frames based on the adjusted quantization parameters. The one or more input frames decoded from the input video bitstream and the corresponding candidate recompressed frames recompressed from the one or more input frames can be obtained. The corresponding candidate recompressed frames can also be decoded from an input recompressed video bitstream corresponding to the input video bitstream. Each candidate recompressed frame can comprise a plurality of candidate recompressed tiles corresponding to the plurality of tiles. Each candidate recompressed tile can include one or more candidate recompressed blocks corresponding to the one or more blocks. The controlling can comprise instructing the video content system to evaluate the candidate recompressed frames using the intricateness values. The controlling can further comprise instructing the video content system to calculate a tile quality score for each of the candidate recompressed tiles based on the intricateness value calculated for each block included in a corresponding tile, the tile quality score being calculated using a quality measure indicative of perceptual quality of a respective candidate recompressed tile. The controlling can further comprise instructing the video content system to apply perceptual weighting to the tile quality score based on the intricateness values calculated for each block in the tile, the perceptual weighting being used in a pooling process of the tile quality scores to form a frame quality score for each input frame. The controlling further comprises: instructing the video content system to adjust the quality criterion for selected input frames, the adjusted quality criterion being used by the video content system to determine whether perceptual quality of the candidate recompressed frames of said selected input frames meet the adjusted quality criterion. High perceptual weighting can be applied to a tile containing at least one block that has a high intricateness value. Perceptual weighting can be applied based on a ratio of a maximum intricateness value in a tile and an average intricateness value of the tile. The perceptual weighting can be applied based on a ratio of a maximum intricateness value in a tile and an average intricateness value of the frame.

In accordance with further aspects of the presently disclosed subject matter, and optionally, in combination with any of the appropriate above aspects, upon a condition being met, the video content system can be instructed to: partition each tile to a plurality of sub-tiles, calculate sub-tile quality scores for corresponding candidate recompressed sub-tiles, and pool sub-tile quality scores to form a tile quality score, wherein at least one of the calculating and pooling is using the intricateness value calculated for each block in a sub-tile. The condition can be that at least one block in the tile has a high intricateness value compared to the rest of blocks in the tile. The condition can be that a maximum intricateness value of a block in the tile is significantly higher than an average intricateness value of blocks in the tile. The condition can further comprise that the maximum intricateness value exceeds a threshold. The intricateness value can be a Motion vector based intricateness value calculated based on the motion vectors and the bit consumption used to encode the block. The intricateness value can be an estimation of amount of information contained in the block to be encoded.

In accordance with other aspects of the presently disclosed subject matter, there is provided a computerized method of controlling a video content system based on an input video bitstream and a recompressed video bitstream, the input video bitstream including encoded data encoded from one or more input frames of a video sequence, the recompressed video bitstream including encoded data recompressed from respective input frames, the method comprising: extracting, from the input video bitstream, encoding information associated with each input frame of said one or more input frames, the encoding information being used in an encoding process of the input frame to encode pixels included in the input frame into corresponding section of the input video bitstream; calculating one or more intricateness values each for a respective input frame based on the encoding information associated therewith, each intricateness value being indicative of encoding difficulty of the respective input frame in the encoding process; and evaluating quality of the recompressed frames using the one or more intricateness values.

In accordance with other aspects of the presently disclosed subject matter, there is provided a computerized system of controlling a video content system based on an input video bitstream and a recompressed video bitstream, the input video bitstream including encoded data encoded from one or more input frames of a video sequence, the recompressed video bitstream including encoded data recompressed from the one or more input frames, the system comprising a processor operatively coupled with a memory and configured to: extract, from the input video bitstream, encoding information associated with each input frame of said one or more input frames, the encoding information being used in an encoding process of the input frame to encode pixels included in the input frame into corresponding section of the input video bitstream; calculate one or more intricateness values each for a respective input frame based on the encoding information associated therewith, each intricateness value being indicative of encoding difficulty of the respective input frame in the encoding process; and evaluate quality of said recompressed frames using the one or more intricateness values.

In accordance with further aspects of the presently disclosed subject matter, and optionally, in combination with any of the appropriate above aspects, the evaluating can comprise calculating a quality score for each of the recompressed frames based on the respective intricateness value, the quality score being calculated using a quality measure indicative of perceptual quality of a respective recompressed frame. The evaluating can comprises adjusting quality criterion for selected input frames, the adjusted quality criterion being used by video content system to determine whether perceptual quality of the recompressed frames of the selected input frames meet the adjusted quality criterion.

In accordance with further aspects of the presently disclosed subject matter, and optionally, in combination with any of the above aspects, the input video bitstream can be encoded using block based encoding scheme, such as for example HEVC and H.264. The one or more blocks can be macro-blocks in H.264. The one or more blocks can also be Coding Tree Units (CTU) or part thereof in HEVC. The quality measure can be selected from a group comprising: Peak Signal to Noise Ratio (PSNR), Structural SIMilarity index (SSIM), Multi-Scale Structural SIMilarity index (MS-SSIM), Video Quality Metric (VQM), Visual information Fidelity (VIF), MOtion-based Video Integrity Evaluation (MOVIE), Perceptual Video Quality Measure (PVQM), quality measure using one or more of Added Artifactual Edges, texture distortion measure, and quality measure combining an inter-frame and intra-frame quality scores.

### BRIEF DESCRIPTION OF THE DRAWINGS

In order to understand the presently disclosed subject matter and to see how it may be carried out in practice, the subject matter will now be described, by way of non-limiting example only, with reference to the accompanying drawings, in which:

FIG. 1 is a functional block diagram schematically illustrating a system for controlling a video content system based on an input video bitstream in accordance with certain embodiments of the presently disclosed subject matter;

FIG. 2 is a generalized flowchart of controlling a video content system based on an input video bit stream using frame level intricateness value in accordance with certain embodiments of the presently disclosed subject matter;

FIG. 3 is a generalized flowchart of controlling a video content system based on an input video bit stream using block level intricateness value in accordance with certain embodiments of the presently disclosed subject matter;

FIG. 4 is an example of two frames illustrating different intricateness, in accordance with certain embodiments of the presently disclosed subject matter;

FIGS. 5a and 5b show another example of two frame pairs illustrating different intricateness;

FIG. 6 is a generalized flowchart of calculating a quality score using a tiling and pooling process in accordance with certain embodiments of the presently disclosed subject matter; and

FIG. 7 is a generalized flowchart of a sub-tiling process in accordance with certain embodiments of the presently disclosed subject matter.

### DETAILED DESCRIPTION

In the following detailed description, numerous specific details are set forth in order to provide a thorough understanding of the disclosed subject matter. However, it will be understood by those skilled in the art that the present disclosed subject matter can be practiced without these specific details. In other instances, well-known methods, procedures, and components have not been described in detail so as not to obscure the present disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “extracting”, “calculating”, “providing”, “instructing”, “encoding”, “decoding”, “applying”, “evaluating”, “obtaining”, “repeating”, “pooling”, “partitioning”, or the like, include action and/or processes of a computer that manipulate and/or transform data into other data, said data represented as physical quantities, e.g. such as electronic quantities, and/or said data representing the physical objects. The term “computer” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof, such as, e.g., the computerized system of controlling a video content system disclosed in the present application.

The operations in accordance with the teachings herein can be performed by a computer specially constructed for the desired purposes or by a general purpose computer specially configured for the desired purpose by a computer program stored in a non-transitory computer readable storage medium.

The term “non-transitory” is used herein to exclude transitory, propagating signals, but to otherwise include any volatile or non-volatile computer memory technology suitable to the presently disclosed subject matter.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately or in any suitable sub-combination.

In embodiments of the presently disclosed subject matter one or more stages illustrated in the figures may be executed in a different order and/or one or more groups of stages may be executed simultaneously and vice versa.

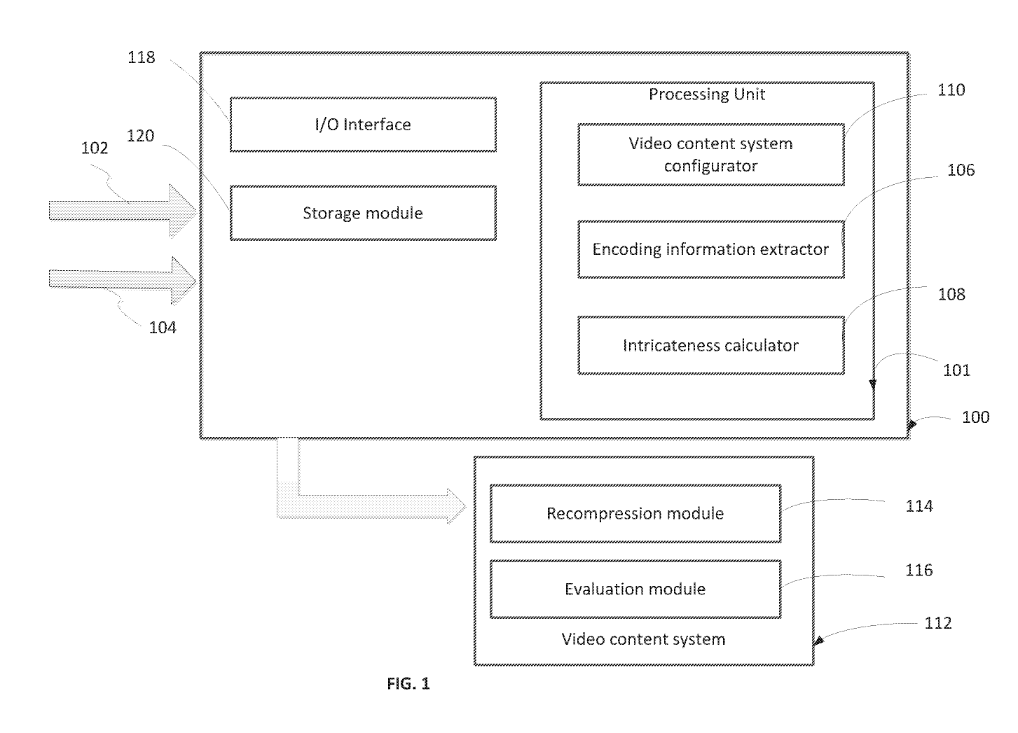

Bearing this in mind, attention is now drawn to FIG. 1, schematically illustrating a functional block diagram of a system for controlling a video content system based on an input video bitstream in accordance with certain embodiments of the presently disclosed subject matter.

According to certain embodiments, there is provided a system 100 for controlling (e.g., optimizing) a video content system based on an input video bitstream 102. The system 100 can comprise a processing unit 101 that includes an encoding information extractor 106, an intricateness calculator 108, and a video content system configurator 110. The system 100 can be operatively connected to a video content system 112 for controlling and configuration purposes, as will be described in detail below. The processing unit 101 can be implemented by a processor such as, e.g., a CPU, configured to execute functionalities of functional modules 106, 108, and 110 in accordance with computer-readable instructions implemented on a non-transitory computer readable storage medium, as may be included in storage module 120. Such functional modules are referred to herein as comprised in the processor.

The system 100 may receive an input video bitstream 102, which is previously encoded using an encoder which combines block based encoding processing followed by entropy coding. Such an input video bitstream includes encoded data encoded from one or more input frames of a video sequence, and each frame comprises one or more blocks. Without limiting the scope of the disclosure in any way, it should be noted that the terms “frame” used in the specification should be expansively construed to include a single video picture, frame, image, field, slice, etc. By way of example, the block based encoding scheme can include but is not limited to one of: MPEG-1, MPEG-2, H.261, H.263, MPEG-4 Part2, MPEG-4 part10, AVC, H.264, HEVC, Motion-JPEG, VP8, VP9, VC-1, WebM or ProRes. The blocks in each frame may be Macro-Blocks (MB), such as in H.264, Coding Tree Units (CTU) as in HEVC, or any other sub-frame unit used in the video encoder.

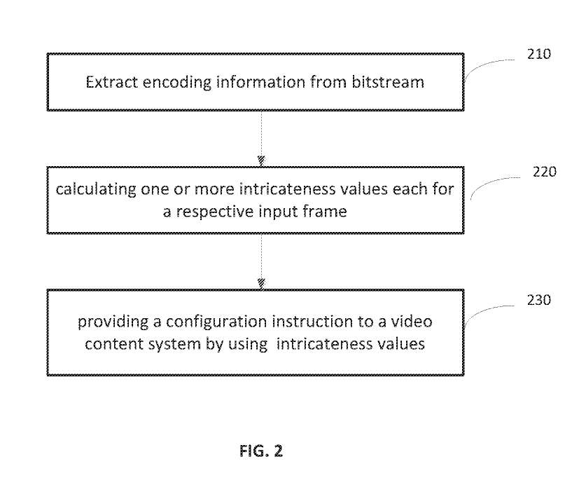

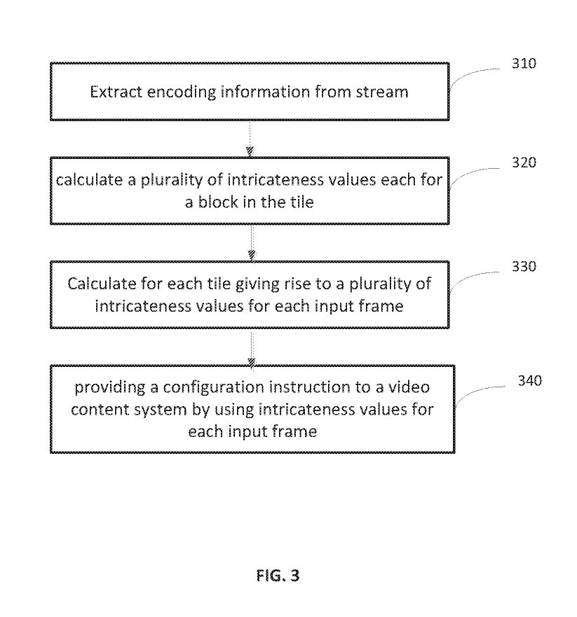

According to certain embodiments, the encoding information extractor 106 can be configured to extract, from the input video bitstream 102, encoding information associated with each input frame of the one or more input frames. The encoding information can be used in an encoding process of the input frame to encode pixels included in the input frame into corresponding section of the input video bitstream. The intricateness calculator 108 can be configured to calculate one or more intricateness values each for a respective input frame based on the encoding information associated therewith. Each intricateness value can be indicative of encoding difficulty of the respective input frame in the encoding process. The video content system configurator 110 can be configured to provide a configuration instruction for controlling the video content system 112 by using the calculated one or more intricateness values, as will be described below with reference to FIGS. 2 and 3.

According to some embodiments, each input frame can be divided into a plurality of tiles, each tile including one or more blocks. Accordingly the encoding information extractor 106 can be configured to extract, from the input video bitstream 102, encoding information associated with each block included in a tile of an input frame. The encoding information can be used in an encoding process of the block to encode pixels included in the block into corresponding section of the input video bitstream. The intricateness calculator 108 can be configured to calculate one or more intricateness values each for a block in the tile based on the encoding information associated therewith. Each intricateness value can be indicative of the encoding difficulty of the block in the encoding process. Similar calculation can be performed for all the tiles in an input frame, giving rise to intricateness values for the input frame. The video content system configurator 110 can be configured to provide a configuration instruction for controlling the video content system 112 by using the one or more intricateness values calculated for each input frame.

The video content system 112 is operatively connected with the system 100, and receives configuration instructions therefrom. According to certain embodiments, the video content system can comprise a recompression module 114 configured to decode the input video bitstream to one or more input frames, and recompress the input frames to respective candidate recompressed frames using the calculated intricateness values. According to some other embodiments, the system 100 can obtain the one or more input frames decoded from an input video bitstream and obtain corresponding candidate recompressed frames recompressed from the one or more input frames, and the video content system 112 can comprise a evaluation module 116 configured to evaluate the compression quality of the candidate recompressed frames using the intricateness values. In some cases the input frames and corresponding candidate recompressed frames can be received by the system 100 from the video content system 112, or alternatively, they can be provided to the system 100 by a user or any other systems or third parties for evaluation purposes. In some other cases, the system 100 can obtain an input video bitstream 102 and corresponding input recompressed video bitstream 104, and can decode the input video bitstream and corresponding recompressed video bitstream to input frames and candidate recompressed frames (e.g., by a decoder module). According to yet further embodiments, the video content system can comprise both a recompression module 114 and an evaluation module 116 so as to be capable to both recompress the input frames to respective candidate recompressed frames using the calculated intricateness values, and evaluate the compression quality of the candidate recompressed frames using the intricateness values, as will be described in detail with reference to FIGS. 2 and 3.

It is to be noted that the terms “candidate recompressed frames” and “recompressed frames” are used interchangeably in the disclosure to refer to frames that are recompressed from the input video frames, the compression quality of which can be evaluated e.g., by a recompression module. These recompressed frames can be obtained, for example, by decoding an input recompressed bitstream, or alternatively, they can be obtained by recompressing the input video frames. The term “candidate” in some cases can indicate that such a recompressed frame can be a candidate for the output recompressed frame. The candidate recompressed frame may go through a quality evaluation process to verify the compression quality thereof and if the quality meets a certain criterion, the candidate recompressed frame can be the output recompressed frame.

According to certain embodiments, the functionality of the video content system 112, or at least part thereof can be integrated within the system 100. By way of example, the system 100 can further comprise the evaluation module 116, and accordingly, instead of providing a configuration instruction to the video content system 112 for evaluation purposes, the system 100 can further evaluate the compression quality of the recompressed frames using one or more intricateness values. By way of another example, the system 100 can further comprise the evaluation module 116, and the video content system can comprise the recompression module 114. The system 100 can evaluate compression quality of the recompressed frames using one or more intricateness values, and provide instructions to the video content system 112 for recompression purposes.

The system 100 can further comprise an I/O interface 118 and a storage module 120 operatively coupled to the other functional components described above. According to certain embodiments, the I/O interface 118 can be configured to obtain an input video bitstream and provide a configuration instruction to the video content system. The storage module 120 comprises a non-transitory computer readable storage medium. For instance, the storage module can include a buffer that holds input frames decoded from an input video bitstream and feed them to the recompression module. In another example, the buffer may also hold the candidate recompressed frames that are decoded from an input recompressed video bitstream. In yet another example, the buffer may also hold preceding frames used in order to calculate an inter-frame quality measure, having a temporal component.

Those versed in the art will readily appreciate that the teachings of the presently disclosed subject matter are not bound by the system illustrated in FIG. 1 and the above exemplified implementations. Equivalent and/or modified functionality can be consolidated or divided in another manner and can be implemented in any appropriate combination of software, firmware and hardware.

While not necessarily so, the process of operation of system 100 can correspond to some or all of the stages of the methods described with respect to FIGS. 2 and 3. Likewise, the methods described with respect to FIGS. 2 and 3 and their possible implementations can be implemented by system 100. It is therefore noted that embodiments discussed in relation to the methods described with respect to FIGS. 2 and 3 can also be implemented, mutatis mutandis as various embodiments of the system 100, and vice versa.

Turning now to FIG. 2, there is shown a generalized flowchart of controlling a video content system based on an input video bit stream using frame level intricateness value in accordance with certain embodiments of the presently disclosed subject matter.

As aforementioned, the input video bitstream including encoded data encoded from one or more input frames of a video sequence can be received, and encoding information associated with each input frame of the one or more input frames can be extracted (210) (e.g., by the encoding information extractor 106) therefrom.

The term “encoding information” used in the specification should be expansively construed to include any information that is used in an encoding process (e.g., a block based encoding process) of the input frame, to encode the pixels included in each input frame (or pixels in each block of the frame) into a set of symbols which is then encoded using entropy encoding to create a corresponding section in the input video bitstream. The block based encoding scheme used in the encoding process can include for example, and without limiting the disclosure in any way, AVC/H.264 or HEVC/H.265.

According to certain embodiments, the encoding information can comprise: 1) the detailed bit consumption of various components in the video bitstream, and 2) the encoder parameters that are used to encode the content of the frame or the block. By way of example, the bit consumption of various components can include one or more of the following: the number of bits used to encode the frame, the number of bits used to encode each block, and the number of bits used to encode the block components, the block components including for instance one or more of the following: block header, block motion vectors, and block coefficients. By way of example, encoding parameters can include, for instance, one or more of the following: encoding mode, the quantizer (e.g., the quantization parameter), and motion vectors used to encode the frame or the block, whose definitions are explained in detail as follows:
Encoding mode: Most video encoders support many different encoding modes for a given frame or block, in order to allow for efficient encoding. There are provided some examples for encoding modes used on most block based video encoders. The encoding mode selected for the frame or block may be INTRA coding, also known as an I frame or block. In some encoders the encoding mode for an INTRA block may further indicate a selected intra prediction mode if supported by the video coding standard where the current block is predicted from neighboring pixels. Another example of encoding mode is INTER or P frames or blocks, where the current frame or block is predicted form pixels in previously coded frames. Yet another encoding mode is Bi-directional, B-frame or block, where the current frame or block is jointly predicted from two or more previously coded frames. The encoding mode may provide further indications regarding which prediction mode was used, for instance if weighted prediction was used, or if a certain frame or block is in skipped or direct mode.
Quantizer: The terms quantizer, quantization parameter, quantizer value, quantization value, quantization matrix are used interchangeably in the present disclosure and without limitation, to imply the parameter or value controlling the encoder quantization process or the extent of quantization to be applied. As known to those skilled in the art, quantization used in image and video processing, is a lossy compression technique achieved by compressing a range of values to a single quantum value. When the number of discrete symbols in a given stream is reduced, the stream becomes more compressible.
Motion vector: A motion vector is used in the motion estimation process. It is used to represent a—block in a frame based on the position of this—block (or a similar one) in another frame, called the reference frame. The motion vector is a two-dimensional vector used for inter prediction that provides an offset from the coordinates in the current input frame to the coordinates in a reference frame, e.g., any previously decoded frame.

Continuing with FIG. 2, one or more intricateness values can be then calculated (220) (e.g., by the intricateness calculator 108) each for a respective input frame based on the encoding information associated therewith. Each intricateness value can be indicative of encoding difficulty of the respective input frame.

The terms “intricateness”, “intricateness measure” and “intricateness value” used in this specification should be expansively construed to include any indication of the encoding difficulty of a frame, or a block in a frame. According to certain embodiments, the intricateness can be used to estimate the amount of information contained in the frame or the block to be encoded. In other words, the intricateness can be an indication of complexity of the content of a frame, or a block in a frame. It can also be an indication of how challenging the content of the frame or the block is to be encoded efficiently.

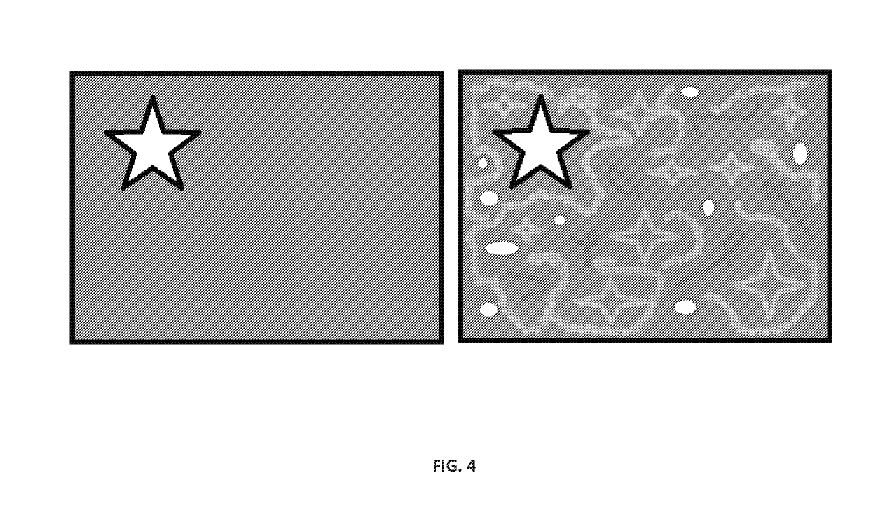

Turning now to FIG. 4, there is shown an example of two frames illustrating different intricateness. The left image is considered to be a relatively less intricate image as it has less complex content as compared to the right image, while the right image shows higher intricateness as it include more complex content than the left one.

In many video coding schemes motion compensation is used to efficiently compress the stream, thus very efficiently representing the visual data which was already present in previous frames, and allocating most of the frame bits to encode the novelty or new information in the frame relative to previous frames in the stream. Therefore, it is quite common for the intricateness to have an uneven spatial distribution across the frame.

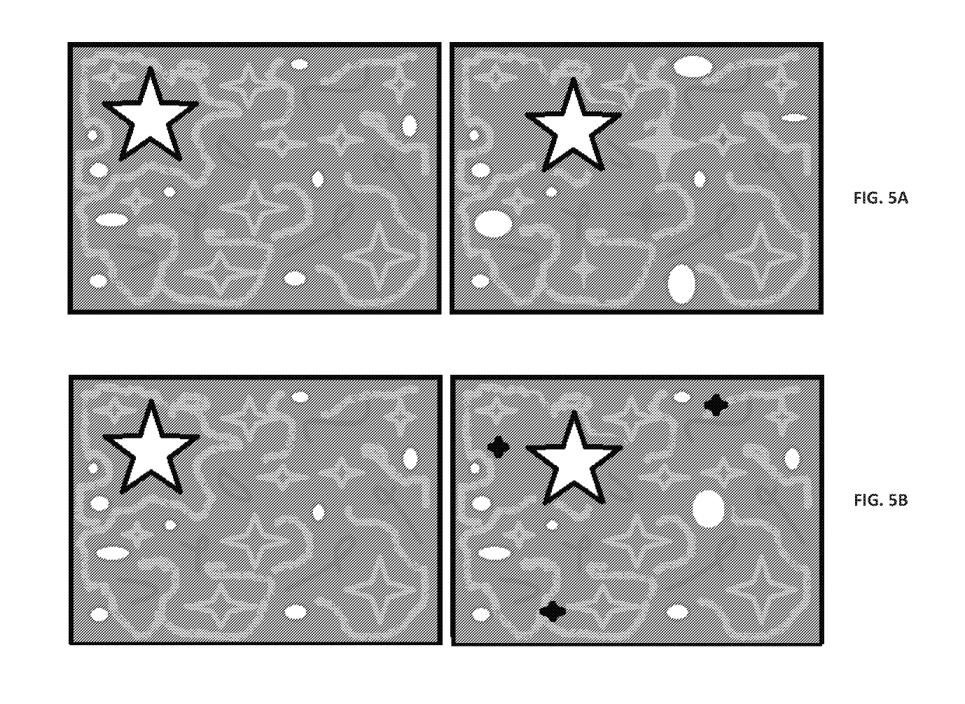

In FIG. 5 there is shown another example of two frame pairs illustrating different intricateness. In the top pair shown in FIG. 5A, the second (right) frame has very little changes compared to the left frame—the only difference being slight movement in the dominant star, while in the bottom pair shown in FIG. 5B the changes in the right frame are much more complex. In case of a video encoder which uses motion compensation, the top right frame, encoded differentially from the top left frame would have lower intricateness than when encoding the bottom right frame based on the same previous frame.

In another example, if there is highly localized motion in one part of the frame, this will usually be reflected in encoding information such as Motion Vector (MV) variance or number of bits used for that area, which will be reflected in the motion vector based intricateness measure introduced above. When calculating a perceptually reliable quality measure for this video frame, it is important to be aware of where the MV based intricateness was high, as these areas will act as focal points to the viewer and therefore maintaining their quality is of the utmost importance. Thus, the quality measure should be configured to correctly represent changes that may be highly localized but have perceptual importance.

In some cases, such as traditional animation or Cel animation, the backgrounds are completely static, and maybe quite intricate in themselves, but the only change between consecutive frames may be limited to very specific changes in character(s) such as a slight movement or even something as subtle as a small facial feature change. As another example, consider a tennis match. The background may be quite intricate consisting for example of a dense crowd of viewers in the bleachers, or some other intricate backdrop. Assume a case where the camera is stable and thus the only change between two consecutive frames may be in the ball, e.g., a change in the ball location. For example, if the ball is moving towards or away from the camera, its size may also change between frames. In this case the novel information in the current frame is highly localized around the ball, and even by using a simple difference measure between two consecutive frames, such as the commonly used Sum of Absolute Differences (SAD). It can be recognized that the information in the current frame is concentrated around the ball. Now, assume a different case where the camera is also slowly panning, or moving. In this case the simple SAD measure will indicate that there is new information present across the frame, or that the entire frame is intricate, whereas in fact, by using encoder motion compensation, most of the frame is very simple to encode, while encoding the ball is more complex. Using the proposed intricateness measures based on encoding information, it would be very easy to pick out either of these cases by looking at MV or QP based intricateness per block values across the frames, as these values will be higher for the blocks holding the tennis ball. This in turn could for instance enable to configure the system to pay more attention to the quality in the ball area, which is the most challenging to encode and also acts as a viewer focal point in the image.

Having described the definition of intricateness, there is now described exemplified calculation of the intricateness measure.

According to certain embodiments, the intricateness value can be calculated based on the bit consumption and the quantization parameter used to encode the input frame or block. One possible measure of intricateness is to look at a value derived from the per-frame or per-block quantization parameter(s) and the number of bits required to encode the frame or block. In addition the coding mode can be taken into account. As is known to those skilled in the art of video compression, the coarser the quantizer used in the encoding process, the less bits will be required to represent a given block or frame in the bitstream, while for a given quantizer value (and a given encoder) more bits will be required for encoding a more intricate block or frame. For example, assume there are two equivalent MBs, encoded with quantizer values QPa and QPb, where QPa represents a larger, or coarser quantizer value than QPb. Then it is expected that the MB encoded with QPb will result in more bits. In another example assume there is a very simple MB and a very complex MB, both encoded with QPc, then it is expected that the complex MB will result in more bits. Note that while the number of required bits depends also on how good a given encoder is, the bit variability across different blocks or frames, within a stream generated by a specific encoder, depends almost entirely on their actual intricateness. Thus by examining these two values jointly, i.e. quantizer level and bit consumption, a good estimate on the block or frame intricateness can be obtained, for example by looking at a geometric average of the QP and B—the bit consumption, i.e. (QP+1)^{x}×B^{y}. In some cases it is possible to add 1 to the QP to avoid zeroing cases of very large bit consumption with a QP value of zero. With x=y=1 the intricateness value will be a simple product of the two values.

For example in an H.264 encoded stream, a per block intricateness measure may be derived from the quantizer or QP value used to encode the corresponding macro-block (MB) and the number of bits required to encode the corresponding MB in the bitstream. Possibly also the MB coding mode would be incorporated, for instance to give different weights to Intra, Inter or Bi-directional encoded MBs. A similar example is intricateness measure per Coding Tree Unit (CTU) in an HEVC bitstream, or at a higher resolution, the intricateness measure per Coding Tree Block (CTB) or even Coding Block (CB). For instance the CTU intricateness may be calculated as the average QP value used in the CTU and the total number of bits in the bitstream corresponding to the same CTU. Possibly other encoding mode decisions such as sub CTU decisions may be incorporated too.

In yet another example, in encoders which perform motion compensation, intricateness may be related to the values and distribution of the Motion Vectors (MVs), possibly combined with the number of bits required to encode the residual obtained after motion compensation. This can be an MV based intricateness measure.

Note that due to encoder structure or syntax, often the first block in the frame requires more bits than other similar blocks in the same frame. To avoid wrongfully interpreting this first block as being overly intricate, the values for the first, or upper-most left block in each frame may be set to the average intricateness value of its three neighboring blocks.

Attention is directed back to FIG. 2, where a configuration instruction can be provided (230) (e.g., by the video content system configurator 110) to a video content system (e.g., the video content system 112) by using the calculated one or more intricateness values.

According to certain embodiments, the input video bitstream can be decoded to one or more input frames, e.g., by the video content system. The configuration instruction can be provided to instruct the video content system (e.g., by the recompression module 114) to recompress the input frames to respective candidate recompressed frames by using the calculated intricateness values. By way of example, the recompression module can be instructed to adjust one or more quantization parameters using one or more intricateness values and recompress the input frames to respective candidate recompressed frames based on the adjusted quantization parameters.

In one embodiment, the intricateness value for each frame can be used to calibrate the level of a compression for a given frame and alter the encoding instructions, such as quantizer values or encoding modes. For example, for frames with lower intricateness values compared to neighboring frames, e.g., the previous frame, the encoding instructions of the previous frame can be reused, rather than calculating new encoding instructions for the current “simpler” frame and performing the calculations required to determine the encoding instructions for this frame. One reason to do this is that in quality aware recompression of the frames with significantly lower intricateness usually requires fewer bits compared to high intricateness frames, thus the increase in bits when compressing such frames to a lesser than maximal extent is relatively low. For instance if a preceding intricate frame required 1000 bits for encoding at a given QP, and the current following frame has much lower intricateness, so that with the same QP value it requires only 100 bits, it would not be very beneficial to invoke the calculation process to determine if a slightly higher QP value would also yield target perceptual quality and may be used, as the expected reduction in bit consumption, say 10 bits, would be negligible when compared to the 1000 bits required to encode the previous frame.

According to some other embodiments, one or more input frames decoded from the input video bitstream and corresponding candidate recompressed frames recompressed from the one or more input frames can be obtained, e.g., from the video content system, or provided by any other system. The configuration instruction can be provided to instruct the video content system (e.g., by the evaluation module 116) to evaluate the compression quality of candidate recompressed frames using the calculated intricateness values. By way of example, the compression quality evaluation can be performed by instructing the evaluation module 116 to calculate a quality score for each of the candidate recompressed frames based on the intricateness value, the quality score being calculated using a quality measure indicative of perceptual quality of a respective candidate recompressed frame. By way of other examples, the compression quality evaluation can be performed by instructing evaluation module 116 to adjust the quality criterion for selected input frames, the adjusted quality criterion being used by evaluation module 116 to determine whether the perceptual quality of the candidate recompressed frames of the selected input frames meets the adjusted quality criterion. The selected input frames can have extreme intricateness values that may be significantly lower or significantly higher than the average intricateness value of frames. By way of yet another example, the compression quality evaluation can be performed by instructing evaluation module 116 to both calculate the quality scores for the candidate recompressed frames and adjust the quality criterion of certain input frames that have extreme intricateness values.

The evaluation module 116 may implement any known quality measures. The term “quality measure” or “quality metric” is used herein to relate to a computable quality measure which provides an indication of video content quality. Such a quality measure receives as input a target image or video frame or a sequence of target video frames (e.g., candidate recompressed frames), and optionally also receives as input a corresponding reference image or video frame or a corresponding sequence of reference video frames (e.g., the input frames decoded from the input video bitstream), and uses various quality metrics or quality measures to calculate a quality score for the target frame or target frame sequence.

One example of a quality metric used herein can be a perceptual quality measure. By way of example, a perceptual quality measure can define a target (e.g., a minimal or a maximal) level of perceptual similarity. In other words, in such an example, the quality criterion can set forth a certain level of perceptual similarity, and the recompression operation can be configured to provide a candidate recompressed frame whose visual appearance, relative to the input video frame, is above (or below) the target level of perceptual similarity. In one example the quality criterion can include a requirement that a candidate recompressed frame is perceptually identical (i.e., the quality measure score is above a certain value) to the corresponding input video frame.

Examples of quality measures that can be utilized herein includes any of the following: as Peak Signal to Noise Ratio (PSNR), Structural SIMilarity index (SSIM), Multi-Scale Structural SIMilarity index (MS-SSIM), Video Quality Metric (VQM), Visual information Fidelity (VIF), MOtion-based Video Integrity Evaluation (MOVIE), Perceptual Video Quality Measure (PVQM), quality measure using one or more of Added Artifactual Edges, texture distortion measure, and a combined quality measure combining inter-frame and intra-frame quality measures, such as described in U.S. patent application Ser. No. 14/342,209 filed on Feb. 28, 2014, and which is incorporated herein in its entirety by reference.

According to certain embodiments, the combined quality measure evaluates, for a given input frame, whether the frame overall quality of a respective compressed video frame (in some other cases it can be a recompressed video frame), measured as a combination of the compressed frame's inter-frame and intra-frame relative perceptual quality, meets a desired quality criterion or not. The combined quality measure can be implemented by computing an intra-frame quality score using an intra-frame quality measure that is applied in the pixel-domain of a current input frame and a corresponding current candidate compressed frame. An inter-frame quality score can also be computed by firstly computing a first difference value from the current input frame and a preceding input frame, and a second difference value from a candidate compressed frame and a preceding compressed frame. The inter-frame quality score for the current candidate compressed frame can then be determined based on a comparison between the first and second difference values.

According to certain embodiments, the intra-frame quality score can optionally be associated with one or more of the following intra-wise quality measures: an added artifactual edges measure, a texture distortion measure, a pixel-wise difference measure and an edge loss measure. By way of example, as part of the intra-frame quality score computation, an added artifactual edges measure can be implemented and an added artifactual edges score can be calculated. The added artifactual edges score can be calculated based on quantifying an extent of added artifactual edges along a video encoding coding block boundary of an encoded frame relative to an input video frame. In some cases, the extent of added artifactual edges can be determined according to a behavior of pixel values (e.g., a change of pixel values) across video coding block boundaries in relation to a behavior of pixel values on either side of respective video coding block boundaries.

By way of another example, as part of the intra-frame quality score computation, a texture distortion measure can be implemented and a texture distortion score can be calculated. The texture distortion measure can be based on relations between texture values in an encoded frame and in a corresponding input video frame. Each texture value corresponds to a variance of pixel values within each one of a plurality of predefined pixel groups in the encoded frame and in each respective pixel group in the corresponding input video frame.

By way of further example, as part of the intra-frame quality score computation, a pixel-wise difference measure can be implemented using a pixel-domain quality measure based on a pixel-wise difference between the video frame and the encoded frame.

By way of yet further example, as part of the intra-frame quality score computation, an edge loss measure can be implemented and an edge loss score can be calculated. For example, the edge loss score computation can include: obtaining an edge map corresponding to a video frame, computing for each edge pixel in the video frame an edge strength score based on a deviation between a value of an edge pixel and one or more pixels in the proximity of the edge pixel, computing for each corresponding pixel in the encoded frame an edge strength score based on a deviation between a value of the corresponding pixel and one or more pixels in the proximity of the corresponding pixel, and the edge loss score is calculated based on a relation among the edge strength score of the edge pixel and the edge strength score of the corresponding pixel.

According to certain embodiments, as part of the inter-frame quality score computation, the first difference value can be calculated based on a pixel-wise difference between an input video frame and a preceding input frame, and the second difference value can be calculated based on a pixel-wise difference between a current encoded frame and a preceding encoded frame encoded from the preceding input frame. Then the inter-frame quality score can be computed based on a comparison of the first difference value and the second difference value, in order to evaluate a temporal consistency of the encoded frame.

Based on the computed intra-frame quality score and inter-frame quality score, an overall quality score for the current candidate compressed frame can be computed. According to some embodiments, such combined quality measure can enable the video encoder to provide a near maximal compression rate for a given input frame while maintaining the overall relative perceptual quality of the respective compressed video frame at a level that meets a desired quality criterion.

In one example, stricter quality criteria may be decided to apply to frames with extreme intricateness values, as these “outstanding” frames may have a strong impact on overall perceived quality. Stricter quality criteria may refer to using a higher threshold for target frame quality, i.e. striving to a higher quality to be considered perceptually identical, or may refer to adapting decisions and thresholds used within the quality measure calculation, for instance to decrease thresholds which determine if a certain level of added artifactual edge is perceptible, thus causing the score to be affected even by subtle artifacts which may ordinarily be considered imperceptible.

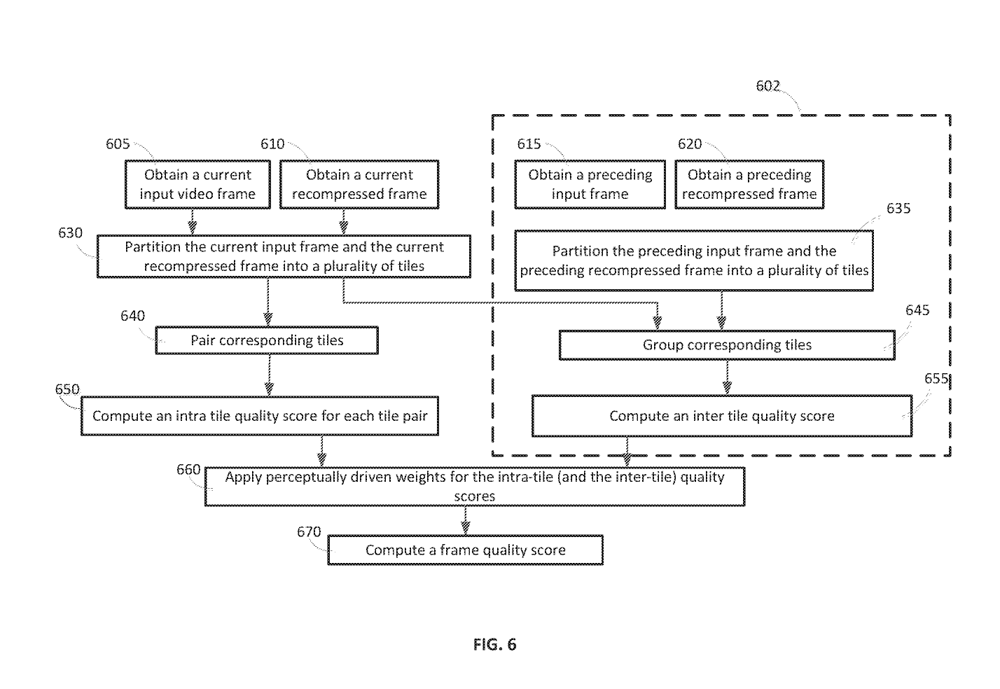

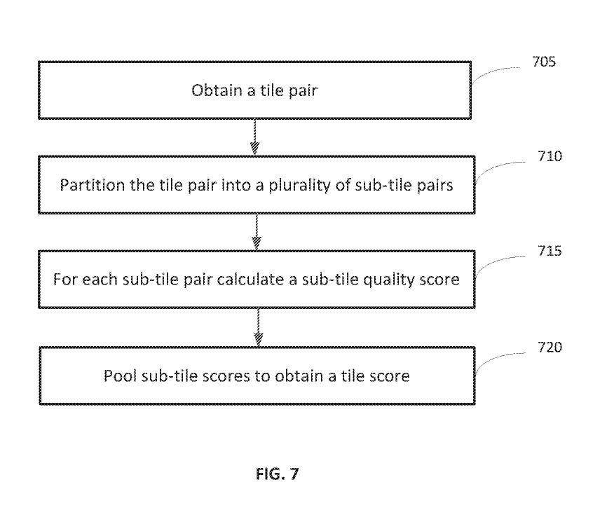

In another example, the calculation of a quality score may be configured by applying stricter temporal continuity across frames according to intricateness values. According to certain embodiments, the quality measure used may have a temporal or inter component which measures temporal consistency between frames, as shown in block 602 of FIG. 6. The sub-tile temporal score pooling method (as shown in 655) may also be selected, for example, according to the differences between each one of the pairs of sub-tiles. The sub-tile pooling method may also be configured according to various per frame intricateness values among adjacent frames, as will be explained in further detail below with respect to FIGS. 6 and 7.

According to further embodiments, quality driven recompression may be performed, where the recompression process is controlled according to a quality measure or quality score. The goal of such a system is to recompress each video frame to provide a near maximal compression rate for a given input frame while maintaining the overall relative perceptual quality of the respective recompressed video frame at a level that meets a desired quality criterion. In such cases, the configuration instruction can be provided to 1) instruct the video content system to recompress the input frames (e.g., by the recompression module 114) to respective candidate recompressed frames by using the calculated intricateness values; and 2) to evaluate the compression quality of candidate recompressed frames using the calculated intricateness values. As aforementioned, the compression quality evaluation can be performed by instructing the evaluation module 116 to either calculate the quality scores for the candidate recompressed frames, or to adjust the quality criterion of certain input frames that have extreme intricateness values, or a combination of both.

According to examples of the presently disclosed subject matter, for each frame in the input video stream, when a candidate recompressed frame meets the quality criterion implemented by the evaluation module 116, the evaluation module 116 will instruct the recompression module 114 to provide the candidate recompressed frame 114 as the output frame for the respective input frame. Thus, in some examples of the presently disclosed subject matter, the proposed method can enable a video content system to provide for a given input stream a respective output video stream, whose overall quality, as measured by the compression quality evaluation module, meets a desired quality criterion.

Turning now to FIG. 3, there is shown a generalized flowchart of controlling a video content system based on an input video bit stream using a block level intricateness value in accordance with certain embodiments of the presently disclosed subject matter.

As aforementioned, the input video bitstream including encoded data pertaining encoded from one or more input frames can be received, each input frame comprising a plurality of tiles, each tile including one or more blocks. According to certain embodiments, an input frame can be partitioned into a plurality of tiles. In some cases, the processing unit 101 of the system 100 can further include a frame partitioning module (not illustrated in FIG. 1) that is adapted to partition each input frame into tiles of a predefined size. Further by way of non-limiting example, tile dimensions can be some multiple of coding block size, such as, e.g., 64×64, 80×80, or 128×128. Further by way of example, the tiles can be square but can also have other shapes or forms. Still further by way of example, tile size can be adapted for instance according to frame resolution, such that, for example, smaller tiles can be used for smaller frames. Yet further by way of example, tile size can be calculated according to the number of tiles that would fit into a given frame, with possible rounding to a whole multiple of coding block size.

The encoding information associated with each block included in a tile of an input frame can be extracted (310) (e.g., by the encoding information extractor 106) therefrom. The encoding information can be used in an encoding process of the block to encode pixels included in the block into corresponding section of the input video bitstream. According to certain embodiments, the encoding information can include bit consumption and encoding parameters used to encode the block. The encoding parameters can include one or more of the following: encoding mode, quantization parameter, and motion vectors used to encode the block, as described in detail with reference to FIG. 2.

A plurality of intricateness values can be calculated (320) (e.g., by the intricateness calculator 106) each for a block in the tile based on the encoding information associated therewith. Each intricateness value can be indicative of encoding difficulty of the block. In some cases the intricateness value can be an estimation of amount of information contained in the block to be encoded.

As aforementioned with reference to FIG. 2, according to certain embodiments, the block level intricateness measure may be based on the number of bits used to encode the block and the encoding parameter per block, e.g., the quantization parameter used to encode the block. By extracting the quantization parameter and the bit consumption per block in each frame of the input stream, and by looking at the product of these two values, the “effort” invested in coding each block can be determined, which serves as an indication of how much novel, or non-predicted, information it contains.

According to certain embodiments, the intricateness value is a Motion vector based intricateness value calculated based on the motion vectors and the bit consumption used to encode the block.

The extracting and calculating intricateness values as recited in step 310 and 320 can be repeated (330) for all tiles included in each input frame, giving rise to a plurality of intricateness values for each input frame.

A configuration instruction for controlling a video content system can be provided (340) by using a plurality of intricateness values calculated for each input frame, in a similar manner as described with reference to step 230 in FIG. 2.

According to certain embodiments, the input video bitstream can be decoded to one or more input frames, e.g., by the video content system. The configuration instruction can be provided to instruct the video content system (e.g., by the recompression module 114) to recompress the input frames to respective candidate recompressed frames by using the calculated intricateness values. Each candidate recompressed frame comprises a plurality of candidate recompressed tiles corresponding to the plurality of tiles, and each candidate recompressed tile includes one or more candidate recompressed blocks corresponding to the one or more blocks.

It is to be noted that the terms “candidate recompressed tiles” and “recompressed tiles” are used interchangeably in the disclosure to refer to tiles that are recompressed from the corresponding tiles included in the input video frames. Similarly, the terms “candidate recompressed blocks” and “recompressed blocks” are used interchangeably in the disclosure to refer to blocks that are recompressed from the corresponding blocks included in the tiles of the input video frames.

According to some other embodiments, one or more input frames decoded from the input video bitstream and corresponding candidate recompressed frames recompressed from the one or more input frames can be obtained, e.g., from the video content system, or provided by any other system. The configuration instruction can be provided to instruct the video content system (e.g., by the evaluation module 116) to evaluate the compression quality of candidate recompressed frames using the calculated intricateness values. In some cases, the configuration instruction can be provided to further instruct the evaluation module 116 to calculate a tile quality score for each of the candidate recompressed tiles based on the intricateness value calculated for each block included in a corresponding tile, the tile quality score being calculated using a quality measure indicative of perceptual quality of a respective candidate recompressed tile. The tile quality score can be calculated also according to the relation among the intricateness values of blocks within the tile and the intricateness values in the blocks outside the tile, for instance whether the average or maximum of the intricateness values of the blocks within the tile is very low or very high compared to the average or maximum intricateness values of the blocks outside the tile. According to further embodiments, the configuration instruction can be provided to further instruct the video content system to apply perceptual weighting to the tile quality score based on the intricateness values calculated for each block in the tile, the perceptual weighting being used in a pooling process of the tile quality scores to form a frame quality score for each input frame, as illustrated in FIG. 6.

Attention is now directed to FIG. 6, illustrating a generalized flowchart of calculating a quality score using a tiling and pooling process in accordance with certain embodiments of the presently disclosed subject matter.

As shown, according to certain embodiments, a current input video frame and a current recompressed frame are obtained (605 and 610), and partitioned (630) respectively into a plurality of tiles and a plurality of recompressed tiles. Each tile and a corresponding recompressed tile are paired (640) together to a tile pair. According to certain embodiments, tiles from the current input video frame are matched with corresponding tiles from the current recompressed frame to provide a plurality of tile pairs. For example, a given tile from the current input video frame which is defined over a given area of the current input frame is matched with a tile from the current recompressed frame which is defined over the corresponding area of the current recompressed frame. An intra-tile quality score is computed (650) for each tile pair. For example, the evaluation module 116 can compute an intra-tile quality score using an intra-tile quality measure that is applied in the pixel-domain of each current tile pair. More details regarding the computation of the intra-frame quality score are described above with reference to FIG. 2. Perceptual weighting or perceptual driven weights can be applied (660) to the intra-tile quality scores for all or at least some of the tile pairs, and a frame quality score can be computed (670) by pooling all the intra-tile quality scores using the applied perceptual weighting.

According to further embodiments, the calculation of a frame quality score can also take into consideration of a temporal or inter component which measures temporal consistency between frames, as illustrated in block 602. A preceding input video frame and a preceding recompressed frame are obtained (615 and 620), and partitioned (635) respectively into a plurality of tiles and a plurality of recompressed tiles. Four tiles each from a preceding input frame, a preceding recompressed frame, a current input frame, and the current recompressed frame respectively are grouped (645) together to a tile group, and an inter-tile quality score is computed (655) for each tile group. By way of example, for each group of tiles, a first difference value can be computed from a tile of the current input frame and a respective tile from the preceding input frame, and a second difference value can be computed from a respective tile of the current recompressed frame and a respective tile of the preceding recompressed frame. Further by way of example, an inter-tile quality score can be computed for a tile of a current recompressed frame based on a comparison between the respective first and second difference values.

Perceptual weighting can be applied to (660) both the intra-tile quality scores and inter-tile quality scores for all or at least some of the tile pairs, and a frame quality score can be computed (670) by pooling all the intra-tile quality scores and inter-tile quality scores using the applied perceptual weighting. For example the perceptual weighting can be applied by a perceptual weighting module (not illustrated in FIG. 1) that can be implemented as part of the processing unit 101. An exemplified tiling and pooling process is described in U.S. patent application Ser. No. 14/342,209 filed on Feb. 28, 2014, and which is incorporated herein in its entirety by reference.

As aforementioned, a tile quality score can be calculated for each of the recompressed tiles based on the intricateness value calculated for each block included in a corresponding tile. According to certain embodiments, the intricateness value can be used in one or more of the following steps: calculating an intra-tile quality score, calculating an inter-tile quality score, and applying perceptual weighting for the intra-tile quality scores and inter-tile quality scores to form a frame quality score. The perceptual weighting uses multiple considerations in the pooling process.

According to certain embodiments, the perceptual weighting module can be adapted to provide more or less weight to particularly dark or particularly bright or saturated tiles. Further by way of example, the perceptual weighting module can be adapted to give more or less weight to poor performing tiles (e.g., tiles with the lower quality scores). For instance, the pooling procedure can be used to emphasize (or give a higher weight to) the worst tile (e.g., the tile with the lowest quality score) in the current recompressed frame, or can also provide for integration of the tile quality scores over the frame, while excluding high quality ‘outliers’, i.e., tiles with particularly high quality compared to the worst case tile. Still further by way of example, the perceptual weighting module can be adapted to give different emphasis to different tiles depending on their location in the frame using appropriate location based weighting of tiles, for instance, the perceptual weighting module can apply weights which emphasize tiles located at the frame's center. It is now proposed to add intricateness consideration to the pooling process, so that the tile perceptual weight will be derived also from the intricateness values of the blocks in the corresponding tile.

According to certain embodiment, the configuration instruction can be provided to instruct the video content system to apply high perceptual weighting to a tile containing at least one block that has a high intricateness value. In some cases, the perceptual weighting can also be applied based on a ratio of a maximum intricateness value in a tile and an average intricateness value of the tile. In some other cases, perceptual weighting is applied based on a ratio of a maximum intricateness value in a tile and an average intricateness value of the frame.

As aforementioned, according to yet further embodiments, the configuration instruction can be provided to both 1) instruct the video content system to recompress the input frames (e.g., by the recompression module 114) to respective candidate recompressed frames by using the calculated intricateness values; and 2) to evaluate the compression quality of candidate recompressed frames (e.g., by the evaluation module 116) using the calculated intricateness values.

According to certain embodiments, upon a condition being met, the configuration instruction can be provided to instruct the video content system (e.g., by the evaluation module 116) to perform a sub-tiling process as described below with reference to FIG. 7.

Attention is directed to FIG. 7, illustrating a generalized flowchart of a sub-tiling process in accordance with certain embodiments of the presently disclosed subject matter.

As shown, a tile pair that includes a tile from a current input video frame and a corresponding recompressed tile from a corresponding recompressed frame can be obtained (705). The tile pair can be partitioned (710) to a plurality of sub-tile pairs. A sub-tile can have a dimension of M×N. For instance, sub-tiles of size 4×4 can be used. For each sub-tile pair or at least some subset thereof, a sub-tile quality score is calculated (715). For instance, an intra-sub-tile quality score can be computed for each sub-tile pair. Optionally, sub-tiles can also be grouped similarly as described with reference to block 645 in FIG. 6, and an inter-sub-tile quality score can be computed for such a group of corresponding sub-tiles. Optionally, perceptually driven weights can be applied to the sub-tile scores. All the sub-tile quality scores can be pooled (720) together to form a tile score. An exemplified sub-tiling process is described in U.S. patent application Ser. No. 14/342,209 filed on Feb. 28, 2014, and which is incorporated herein in its entirety by reference.

The intricateness value calculated for each block in a sub-tile can be used in at least one of the following processes: the calculation of sub-tile quality scores, and the pooling of sub-tile quality scores. According to certain embodiments, the condition to provide such configuration instruction with respect to calculating and pooling sub-tile quality scores can be that, for example, at least one block in the tile exhibit extreme intricateness value, e.g., has a high intricateness value compared to the rest of blocks in the same tile or the same frame. Upon the condition being met, the sub-tile pooling can be configured by using the intricateness value. For example, a stricter sub-tile pooling process can be used. Stricter pooling may be applied for instance by emphasizing the sub-tiles with the greatest difference or distortion value, or by using a finer sub-tile grid-resulting in more, smaller, sub-tiles. For instance, stricter sub tile pooling may imply that the weights between sub-tiles vary more. For example, if in one pooling scheme any sub-tile score that is larger than the minimum sub-tile score by more than a factor of 2.5 is given a weight of 0—i.e. excluded from the pooling, whereas in a second scheme any sub-tile score that is larger than the minimum sub-tile score by more than a factor of 1.5 is given a weight of 0—i.e. excluded from the pooling, the second scheme can be considered as applying a stricter pooling approach. The stricter sub-tile pooling will improve score reliability since severe artifacts introduced in very small areas of the tile will not be averaged out over the tile.

By way of example, the condition can be that a maximum intricateness value of a block in the tile is significantly larger than an average intricateness value of blocks in the tile, for instance larger by more than a factor of 5, a stricter sub-tile pooling may be applied. According to further embodiments, the condition can further comprise that the maximum intricateness value in a tile exceeds a threshold, to avoid wrongfully assuming high intricateness in the following case: when there is almost no information in the block some encoders can spend zero bits on such consecutive blocks. Then, after encountering a number of such blocks, some bits are sent—even though the current block may not be more intricate, but rather due to the structure of the encoder entropy coding. When using for instance a product of the QP and the bit consumption as an intricateness measure, this will show a high ratio between the intricateness of the block associated with the transmitted bits, and the previous blocks which were encoded with zero bits, and this is not reflective of their relative intricateness.

In another example, in some cases, when the maximum intricateness value over blocks within the tile is significantly larger than the average intricateness value of blocks in the same tile, for instance larger by more than a factor of 5, and also the maximum intricateness value in the tile is particularly high and much larger than the average intricateness value of blocks in the frame, for instance larger by more than a factor of 50, then even stricter quality criteria for this tile may be applied for instance by adapting a threshold used within the quality measure calculation, or by adding a correction factor or penalty to the tile score which is proportional to this ratio among the maximum block intricateness and the average frame intricateness.

In some embodiments the quality measure used may already apply various penalties or stricter quality criteria to frames or blocks according to specific characteristics. For example it is proposed according to examples of the disclosed subject matter to apply a penalty or correction factor, to a quality score of tiles which are particularly dark, e.g., have a low maximum Y or Luminance pixel value) or to tiles of frames that have particular distributions such as “titles” frames. In the embodiments described herein any proposed penalties applied due to localized intricateness must be verified to work in synergy with previously applied modifications for such frames, for instance by limiting the penalty applied to “titles” frames when the intricateness tools were invoked for the same frame.

Those versed in the art will readily appreciate that the examples illustrated with reference to FIGS. 2 and 3 are by no means inclusive of all possible alternatives but are intended to illustrate non-limiting examples, and accordingly other ways of measurement and calculation can be used in addition to or in lieu of the above.

According to certain embodiments, there is further provided a computerized method of controlling a video content system based on an input video bitstream and a recompressed video bitstream. The input video bitstream includes encoded data pertaining to one or more input frames. The recompressed video bitstream includes encoded data pertaining to one or more recompressed frames recompressed from respective input frames.

The method comprises the following steps: extracting, from the input video bitstream, encoding information associated with each input frame; calculating one or more intricateness values each for a respective input frame based on the encoding information associated therewith, each intricateness value being indicative of encoding difficulty of the respective input frame; and evaluating quality of the recompressed frames using the one or more intricateness values, as described above in detail with reference to FIGS. 2 and 3.

By way of example, the evaluating can comprise calculating a quality score for each of the recompressed frames based on the respective intricateness value. The quality score is calculated using a quality measure indicative of perceptual quality of a respective recompressed frame.

By way of further example, the evaluating can comprise adjusting quality criterion for selected input frames. The adjusted quality criterion is used by the video content system to determine whether perceptual quality of the recompressed frames of the selected input frames meets the adjusted quality criterion.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A computerized method of controlling a video content system based on an input video bitstream, said input video bitstream including encoded data encoded from one or more input frames of a video sequence, the method comprising:
extracting, from the input video bitstream, encoding information associated with each input frame of said one or more input frames, the encoding information being used in an encoding process of the input frame to encode pixels included in the input frame into corresponding section of the input video bitstream;
calculating one or more intricateness values each for a respective input frame based on the encoding information associated therewith, each intricateness value being indicative of encoding difficulty of the respective input frame in said encoding process; and
providing a configuration instruction for controlling a video content system by using said one or more intricateness values.

2. The computerized method of claim 1, wherein said encoding information includes bit consumption and encoding parameters used to encode each said input frame.

3. The computerized method of claim 2, wherein said encoding parameters include one or more of the following: encoding mode, quantization parameter, and motion vectors used to encode each said input frame.

4. The computerized method of claim 2, wherein said intricateness value is calculated based on the bit consumption and the quantization parameter used to encode the input frame.

5. The computerized method of claim 1, wherein said input video bitstream being decoded to said one or more input frames by said video content system, and wherein said controlling comprises instructing the video content system to recompress the input frames to respective candidate recompressed frames using said intricateness values.

6. The computerized method of claim 1, further comprising obtaining said one or more input frames decoded from said input video bitstream and obtaining corresponding candidate recompressed frames recompressed from said one or more input frames, wherein said controlling comprises instructing the video content system to evaluate compression quality of said candidate recompressed frames using said intricateness values.

7. The computerized method of claim 5, wherein said controlling further comprises:
instructing the video content system to calculate a quality score for each of the candidate recompressed frames based on the intricateness value, said quality score being calculated using a quality measure indicative of perceptual quality of a respective candidate recompressed frame.

8. The computerized method of claim 6, wherein said controlling comprises:
instructing the video content system to calculate a quality score for each of the candidate recompressed frames based on the intricateness value, said quality score being calculated using a quality measure indicative of perceptual quality of a respective candidate recompressed frame.

9. The computerized method of claim 5, wherein said controlling further comprises:
instructing the video content system to adjust quality criterion for selected input frames, said adjusted quality criterion being used by the video content system to determine whether perceptual quality of the candidate recompressed frames of said selected input frames meet said adjusted quality criterion.

10. The computerized method of claim 7, wherein said controlling further comprises:
instructing the video content system to adjust quality criterion for selected input frames, said adjusted quality criterion being used by the video content system to determine whether the perceptual quality of the candidate recompressed frames of said selected input frames meet said adjusted quality criterion.

11. The computerized method of claim 1, wherein the intricateness value is an estimation of amount of information contained in the respective input frame to be encoded.

12. A computerized method of controlling a video content system based on input video bitstream, said input video bitstream including encoded data encoded from one or more input frames of a video sequence, each input frame comprising a plurality of tiles, each tile including one or more blocks, the method comprising:
i) extracting, from the input video bitstream, encoding information associated with each block included in a tile of an input frame, the encoding information being used in an encoding process of the block to encode pixels included in the block into corresponding section of the input video bitstream;
ii) calculating a plurality of intricateness values each for a block in the tile based on the encoding information associated therewith, each said intricateness value being indicative of encoding difficulty of the content of said block in the encoding process;
iii) repeating said i) and ii) for each tile included in each input frame, giving rise to a plurality of intricateness values for each input frame;
iv) providing a configuration instruction for controlling a video content system by using said plurality of intricateness values for each input frame.

13. The computerized method of claim 12, wherein said encoding information includes bit consumption and encoding parameters used to encode the block.

14. The computerized method of claim 13, wherein said encoding parameters include one or more of the following: encoding mode, quantization parameter, and motion vectors used to encode the block.

15. The computerized method of claim 13, wherein said intricateness value is calculated based on the bit consumption and the quantization parameter used to encode the block.

16. The computerized method of claim 12, wherein said input video bitstream being decoded to said one or more input frames by said video content system, and wherein said controlling comprises instructing the video content system to recompress the input frames to respective candidate recompressed frames using said intricateness values, each candidate recompressed frame comprising a plurality of candidate recompressed tiles corresponding to said plurality of tiles, each candidate recompressed tile including one or more candidate recompressed blocks corresponding to said one or more blocks.

17. The computerized method of claim 12, further comprising obtaining said one or more input frames decoded from said input video bitstream and obtaining corresponding candidate recompressed frames recompressed from said one or more input frames, each candidate recompressed frame comprising a plurality of candidate recompressed tiles corresponding to said plurality of tiles, each candidate recompressed tile including one or more candidate recompressed blocks corresponding to said one or more blocks;
wherein said controlling comprises instructing the video content system to evaluate said candidate recompressed frames using said intricateness values.

18. The computerized method of claim 16, wherein said controlling comprises:
instructing the video content system to calculate a tile quality score for each of the candidate recompressed tiles based on the intricateness value calculated for each block included in a corresponding tile, said tile quality score being calculated using a quality measure indicative of perceptual quality of a respective candidate recompressed tile.

19. The computerized method of claim 18, wherein said controlling further comprises:
instructing the video content system to apply perceptual weighting to the tile quality score based on the intricateness values calculated for each block in the tile, said perceptual weighting being used in a pooling process of the tile quality scores to form a frame quality score for each input frame.

20. The computerized method of claim 19, wherein said applying perceptual weighting further comprises applying high perceptual weighting to a tile containing at least one block that has a high intricateness value.

21. The computerized method of claim 19, wherein said perceptual weighting is applied based on a ratio of a maximum intricateness value in a tile and an average intricateness value of the tile.

22. The computerized method of claim 19, wherein said perceptual weighting is applied based on a ratio of a maximum intricateness value in a tile and an average intricateness value of the frame.

23. The computerized method of claim 18, further comprising, upon a condition being met, instructing the video content system to:
partition a tile pair including a tile and a corresponding candidate recompressed tile to a plurality of sub-tile pairs, each sub-tile pair including a sub-tile and a corresponding candidate recompressed sub-tile,
calculate a sub-tile quality score for each sub-tile pair, giving rise to a plurality of sub-tile quality scores for the tile, and
pool the sub-tile quality scores to form a tile quality score, wherein at least one of said calculating and pooling is using the intricateness value calculated for each block.

24. The computerized method of claim 23, wherein said condition is that at least one block in the tile has a high intricateness value compared to the rest of blocks in the tile.

25. The computerized method of claim 23, wherein said condition is that a maximum intricateness value of a block in the tile is significantly larger than an average intricateness value of blocks in the tile.

26. The computerized method of claim 25, wherein said condition further comprises that the maximum intricateness value exceeds a threshold.

27. The computerized method of claim 12, wherein said intricateness value is an estimation of amount of information contained in the block to be encoded.

28. The computerized method of claim 1, wherein the input video bitstream is encoded using block based encoding scheme.

29. The computerized method of claim 12, wherein said one or more blocks are macro-blocks in H.264.

30. The computerized method of claim 12, wherein said one or more blocks are Coding Tree Units (CTU) or part thereof in HEVC.

31. The computerized method of claim 14, wherein the intricateness value is a Motion vector based intricateness value calculated based on the motion vectors and the bit consumption used to encode the block.

32. The computerized method of claim 7, wherein said quality measure is selected from a group comprising: Peak Signal to Noise Ratio (PSNR), Structural SIMilarity index (SSIM), Multi-Scale Structural SIMilarity index (MS-SSIM), Video Quality Metric (VQM), Visual information Fidelity (VIF), MOtion-based Video Integrity Evaluation (MOVIE), Perceptual Video Quality Measure (PVQM), quality measure using one or more of Added Artifactual Edges, texture distortion measure, and quality measure combining an inter-frame and intra-frame quality scores.

33. The computerized method of claim 5, wherein said controlling comprises instructing a video encoder to recompress an input frame having an intricateness value lower than a previous input frame by using the same encoding instruction as the previous input frame.

34. The computerized method of claim 19, wherein said controlling further comprises: instructing the video content system to adjust quality criterion for selected input frames, said adjusted quality criterion being used by the video content system to determine whether perceptual quality of the candidate recompressed frames of said selected input frames meet said adjusted quality criterion.

35. A computerized method of controlling a video content system based on an input video bitstream and a recompressed video bitstream, said input video bitstream including encoded data encoded from one or more input frames of a video sequence, said recompressed video bitstream including encoded data recompressed from said one or more input frames, the method comprising:
extracting, from the input video bitstream, encoding information associated with each input frame of said one or more input frames, the encoding information being used in an encoding process of the input frame to encode pixels included in the input frame into corresponding section of the input video bitstream;
calculating one or more intricateness values each for a respective input frame based on the encoding information associated therewith, each intricateness value being indicative of encoding difficulty of the respective input frame in the encoding process; and
evaluating quality of said recompressed frames using said one or more intricateness values.

36. The computerized method of claim 35, wherein said evaluating comprises calculating a quality score for each of the recompressed frames based on the respective intricateness value, said quality score being calculated using a quality measure indicative of perceptual quality of a respective recompressed frame.

37. The computerized method of claim 35, wherein said evaluating comprises adjusting quality criterion for selected input frames, said adjusted quality criterion being used by video content system to determine whether perceptual quality of the recompressed frames of said selected input frames meet said adjusted quality criterion.

38. The computerized method of claim 5, wherein said controlling comprises instructing the video content system to adjust one or more quantization parameter using said one or more intricateness values and recompress the input frames to respective candidate recompressed frames based on said adjusted quantization parameters.

39. The computerized method of claim 5, wherein said corresponding candidate recompressed frames are decoded from an input recompressed video bitstream corresponding to the input video bitstream.

40. A computerized system of controlling a video content system based on an input video bitstream, said input video bitstream including encoded data encoded from one or more input frames of a video sequence, the system comprising a processor operatively coupled with a memory configured to:
extract, from the input video bitstream, encoding information associated with each input frame of said one or more input frames, the encoding information being used in an encoding process of the input frame to encode pixels included in the input frame into corresponding section of the input video bitstream;
calculate one or more intricateness values each for a respective input frame based on the encoding information associated therewith, each intricateness value being indicative of encoding difficulty of the respective input frame in the encoding process; and
provide a configuration instruction for controlling a video content system by using said one or more intricateness values.

41. A computerized system of controlling a video content system based on input video bitstream, said input video bitstream including encoded data encoded from one or more input frames, each input frame comprising a plurality of tiles, each tile including one or more blocks, the system comprising a processor operatively coupled with a memory and configured to:
i) extract, from the input video bitstream, encoding information associated with each block included in a tile of an input frame, the encoding information being used in an encoding process of the block to encode pixels included in the block into corresponding section of the input video bitstream;
ii) calculate a plurality of intricateness values each for a block in the tile based on the encoding information associated therewith, each said intricateness value being indicative of encoding difficulty of said block in the encoding process;
iii) repeat said i) and ii) for each tile included in each input frame, giving rise to a plurality of intricateness values for each input frame;
iv) provide a configuration instruction for controlling a video content system by using said plurality of intricateness values for each input frame.

42. A computerized system of controlling a video content system based on an input video bitstream and a recompressed video bitstream, said input video bitstream including encoded data encoded from one or more input frames of a video sequence, said recompressed video bitstream including encoded data recompressed from said one or more input frames, the system comprising a processor operatively coupled with a memory and configured to:
extract, from the input video bitstream, encoding information associated with each input frame of said one or more input frames, the encoding information being used in an encoding process of the input frame to encode pixels included in the input frame into corresponding section of the input video bitstream;
calculate one or more intricateness values each for a respective input frame based on the encoding information associated therewith, each intricateness value being indicative of encoding difficulty of the respective input frame in the encoding process; and
evaluate quality of said recompressed frames using said one or more intricateness values.
